(19) United States
(12) Patent Application Publication
(10) Pub. No.: US 2003/0151921 A1
(43) Pub. Date: Aug. 14, 2003

(54) Lamp head with multiple luminous modes

(76) Inventor: Zhao-Cheng Chen, Taipei (TW)

Correspondence Address: Zhao-Cheng Chen, 235 Chung-Ho, Box 8-24, Taipei, TW

(21) Appl. No.: 10/074,443

(22) Filed: Feb. 13, 2002

(51) Int. Cl. F21V 1/12; F21V 17/16

(52) U.S. Cl. 362/360; 362/351; 362/438; 362/433

(57) ABSTRACT

A lamp head with multiple luminous modes has a frame body. A lateral side of the frame body having a through hole. An inner wall of the through hole has a plurality of clamp seats. Each clamp seat has a positioning pin and an elastomer. Masks are installed on the positioning pin and are clamped by the clamp seat so as to be positioned in the frame body. Thereby, the assembly of the lamp head is formed. The masks are made of material with the same or different transparencies. Thereby, when the light is emitted, by the arrangement of the masks, the lamp present a luminous modes selected from same transparency at two sides different transparencies at two sides, and only one side being transparent.

### FIELD OF THE INVENTION

The present invention relates to lamp heads, and particularly to a lamp head with multiple luminous modes.

### BACKGROUND OF THE INVENTION

A prior art lamp head is disclosed in U.S. Design No. 407,519, assigned to the applicant of the present invention. A lamp seat is retained with a lamp rod. The lamp head is firmly secured to the lamp rod. A mask covers the lamp head for shielding light and presenting a beautiful outlook. In that structure, the lamp head is connected with the lamp rod and light is emitted downwards by the arrangement of the mask, and thus the radiating direction is confined. Moreover, when it is desired to adjust the emitting direction of light, it is only necessary to rotate the mask around the lamp head. If the lamp head is adjusted to a direction so that the light emitting direction is toward the view's eyes, the users will feel uneasy. Therefore, the conventional lamp is only used for the general object, but can not be used as a decoration or as an auxiliary illuminator.

To improve the defect in the prior art, the inventor of the present invention discloses a patent, U.S. Pat. No. 5,825,637, (referring to FIG. 1A). In this prior art, the lamp rod can be positioned in the mask and a shielding piece behind the lamp head is used so that light can radiate backwards. When it is desired to adjust the mask so as to change the radiating direction, the mask and lamp head are pivotally rotated so as to assure that as the mask is rotated to a desired direction, the emitting light will not directly radiate to the user's eyes. However, above prior art needs many components, and the cost is high. Furthermore, after it is used for a longer time, the structure will become loose.

### SUMMARY OF THE INVENTION

Accordingly, the primary object of the present invention is to provide a lamp head with multiple luminous modes, wherein the frame body and the masks of the lamp head are modulized, The assembled work is easy, it is only necessary to insert a bulb into the lamp head. By the present invention, the cost can be reduced effectively and the competition of the product can be increased.

Another object of the present invention is to provide a lamp head with multiple luminous modes, wherein the lamp head may be used with lamp seat of any form and provides desired radiating mode. When the lamp head has been adjusted to a desired orientation, the radiating light does not emit to human body so that the user will feel easy. Furthermore, even after it is used for a long time, the lamp head will be loose.

Another object of the present invention is to provide a lamp head with multiple luminous modes, wherein the masks of the present invention can be made of material with the same or different transparencies. Since the material of the masks are selected from materials with the same or different transparencies, for example, the mask 4b is wholly transparent, mask 4b is semitransparent, and mask is opaque. When the light is emitted, by the arrangement of the masks, different luminous modes of the same transparency at two sides, different transparencies at two sides, and only one side being transparent can be selected.

The various objects and advantages of the present invention will be more readily understood from the following detailed description when read in conjunction with the appended drawing.

### BRIEF DESCRIPTION OF THE DRAWINGS

FIG. 1 is a perspective view about the U.S. Design No. 407,519.

FIG. 1A is an exploded perspective view about the U.S. Pat. No. 5,825,637.

FIG. 2 is an exploded perspective view of the present invention.

FIG. 3 is an assembled perspective view of the present invention.

FIG. 4 is a partial cross sectional view of the present invention.

FIG. 5 is a perspective view about the embodiment showing that the present invention is assembled to a lamp seat.

FIG. 6 is a cross sectional view showing that a whole transparent mask and a semitransparent mask are assembled to a frame body.

FIG. 7 is a cross sectional view showing that a whole transparent mask and a nontransparent mask are assembled to a frame body.

FIG. 8 shows that masks of different shapes are assembled in the present invention.

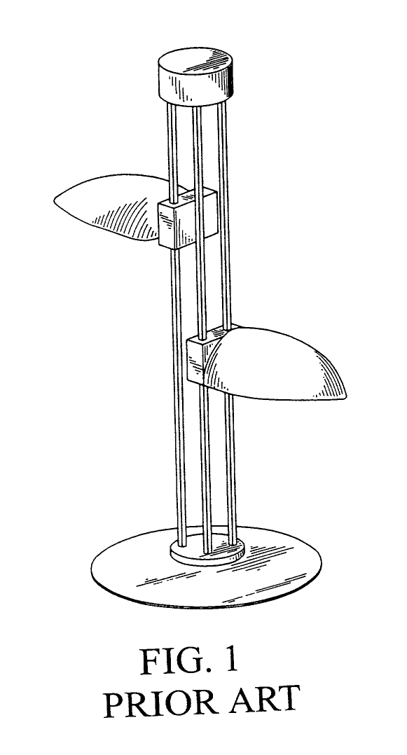

### DETAILED DESCRIPTION OF THE PREFERRED EMBODIMENTS

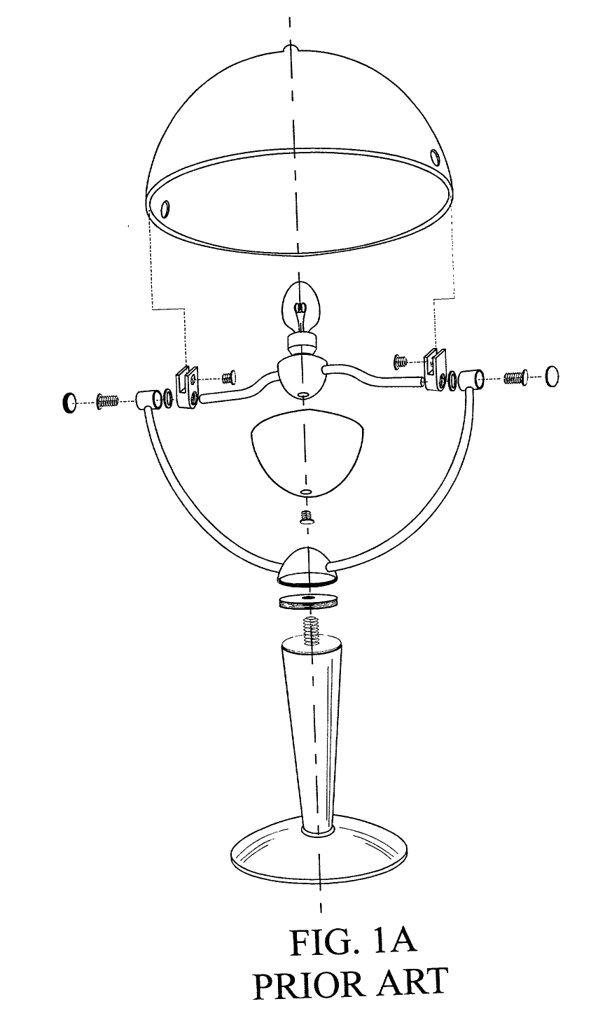

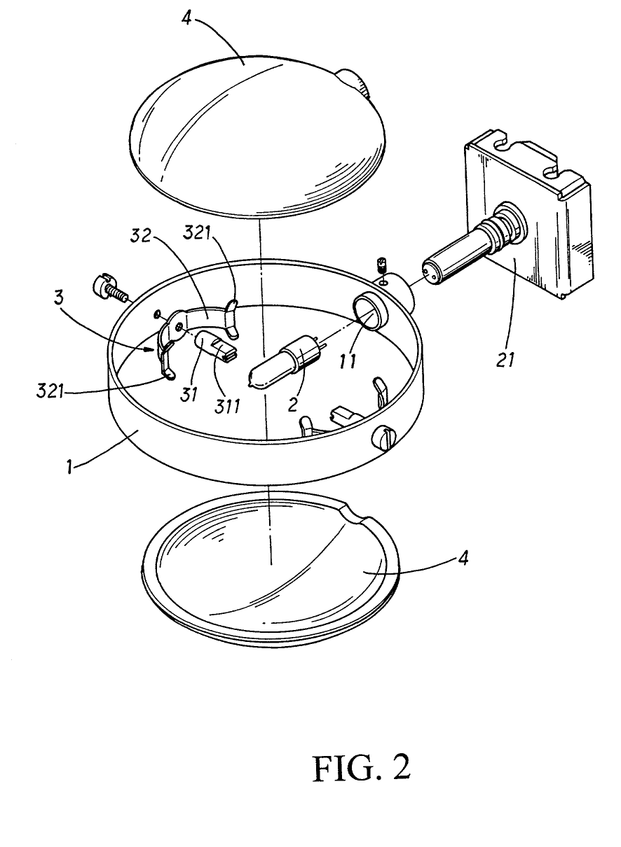

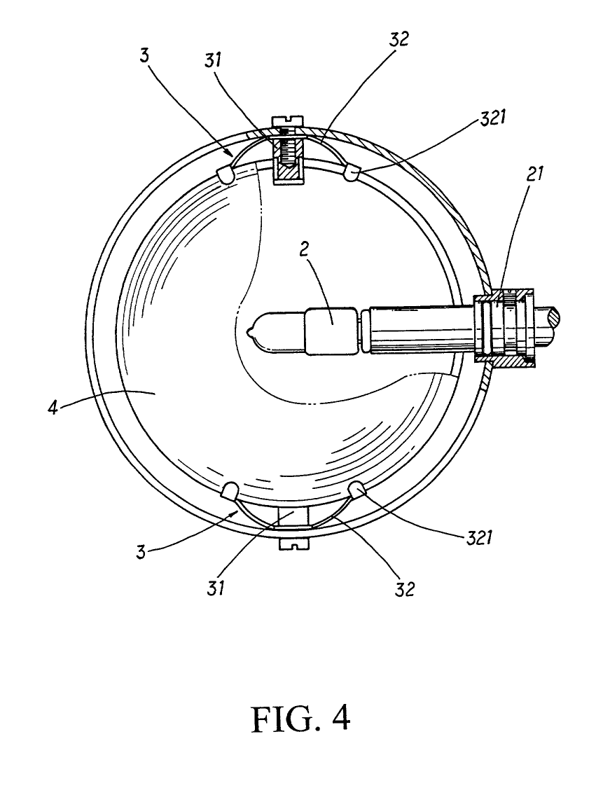

Referring to FIGS. 2 to 5, the lamp head with multiple luminous modes of the present invention is illustrated. The lamp head has a frame body 1. A lateral side of the frame body I has a through hole 11. The inner wall of the through hole 11 has a plurality of clamp seats 3. Each clamp seat 3 has a positioning pin 31 and an elastomer 32. Two sides of the elastomer 32 have respective buckles 321 . A mask 4 is installed at a cutting surface 311 of the positioning pin 31 and is clamped by the buckles 321 at two sides of the elastomer 32 and the clamp seat 3 so as to be positioned in the frame body 1. Thereby, the assembly of the lamp head is formed. Then the lamp head is further assembled with the conductive seat 21 out of the bulb 2 and then is buckled to the lamp rod 22 for acquiring electric power. Therefore, a lamp is formed.

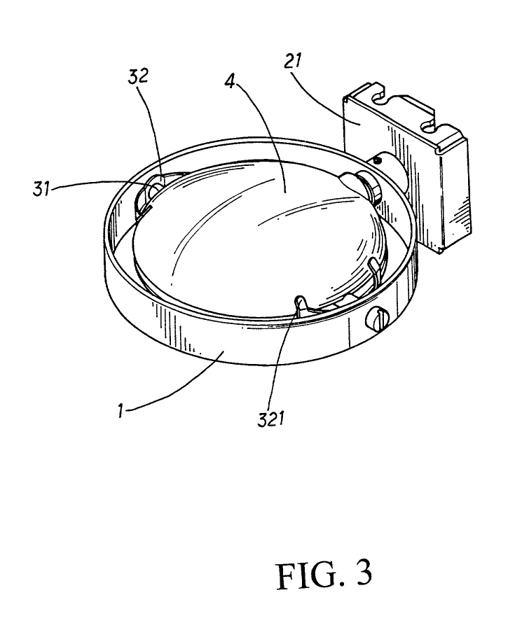

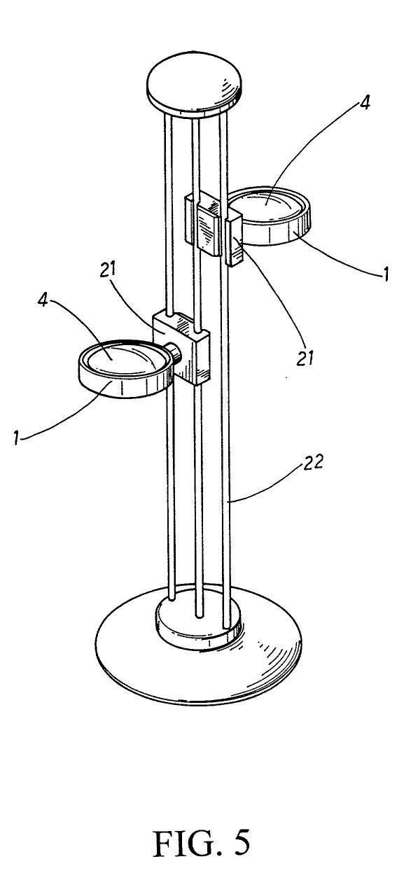

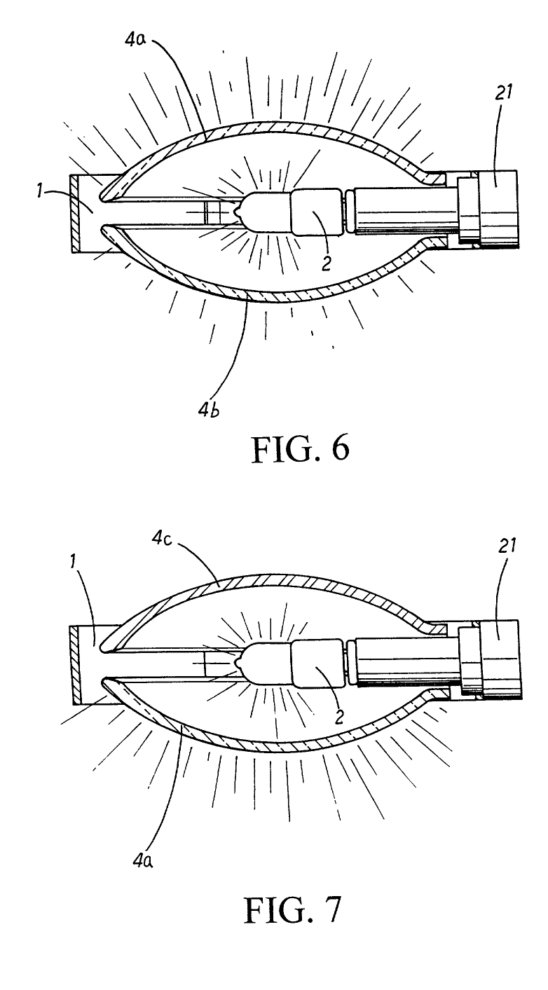

Referring to FIGS. 4, 6, and 7. The masks 4a, 4b or 4c are installed at two sides of the positioning pin 31 and are clamped by the elastomer 32 and the buckles 321 so as to be positioned in the frame body 1. The masks 4a, 4b or 4c can be made of material with the same or different transparencies. Thereby, when the bulb 2 lights up and emits light to the masks 4a, 4b or 4c, since the material of the masks 4a, 4b or 4c are selected from materials with the same or different transparencies, for example, the mask 4b has wholly transparent, mask 4b is semitransparent, and mask 4b is opaque, when the light is emitted, by the arrangement of the masks, different luminous modes of the same transparency at two sides, different transparencies at two sides, and only one side being transparent can be selected.

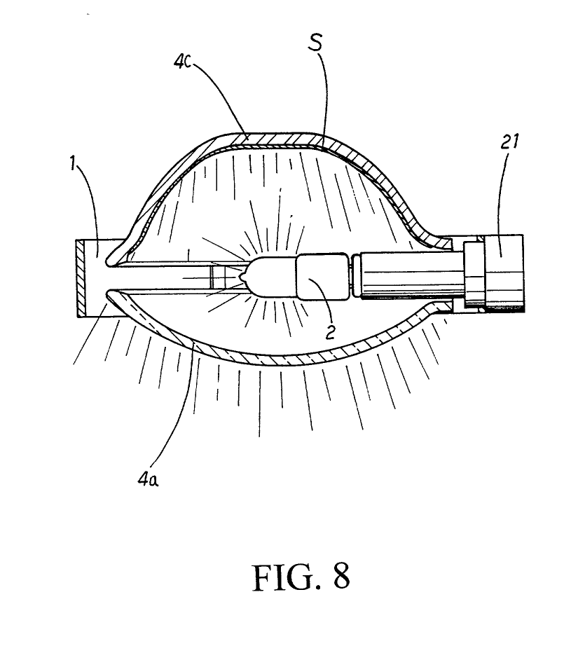

Moreover, the mask 4d of the present invention may be formed by different shape, referring to FIG. 8, the bulb is positioned in the conductive seat 21. The conductive seat 21 is buckled to the lamp rod 22 and can slide or be positioned thereon. The conductive seat 21 can absorb electric energy from the lamp rod 22 and is electrically connected with the bulb 2 by joint connection The lamp can provide preferred illumination despite of the position of the frame body. Furthermore, the inner surface of the mask 4d is coated with reflecting material S. Thereby, as the bulb 2 lights up, a mode of transmitting unidirectionally can be used. Thereby, the light can be reflected wholly so as to have a preferred illumination.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A lamp head with multiple luminous modes having a frame body; a lateral side of the frame body having a through hole; an inner wall of the through hole having a plurality of clamp seats; each clamp seat having a positioning pin and an elastomer, masks being installed on the positioning pin and is clamped by the clamp seat so as to be positioned in the frame body; thereby, the lamp head is formed.

2. The lamp head with multiple luminous modes as claimed in claim 1, wherein a front end of the positioning pin has a cut surface; two sides of the elastomer have respective buckles; thereby, as masks are coupled; the coupled masks are positioned through the positioning pin and buckles.

3. The lamp head with multiple luminous modes as claimed in claim 1, wherein the masks are installed at two sides of the positioning pin and are clamped by the clamp seat so as to be disposed in the frame body;
the masks are made of material with the same or different transparencies; thereby, when light is emitted along a direction due to the arrangement of the masks, the lamp presents various luminous modes containing a first mode of same transparency at two sides, a second mode of different transparencies at two sides, and a third mode of only one side being transparent.

4. The lamp head with multiple luminous modes as claimed in claim 1, wherein the shape of the masks are selectable, a bulb is positioned in the frame body, an outer side of the bulb is installed with a clamp seats; the conductive seat is buckled to the lamp rod and can slide or be positioned thereon; the conductive seat absorbs electric energy from the lamp rod and is electrically connected with the bulb by joints; thereby, the lamp provide preferred illumination despite the position of the frame body.

5. The lamp head with multiple luminous modes as claimed in claim 1, wherein an inner surface of the mask is coated with reflecting material; thereby, as the bulb lights up, a mode of transmission unidirectionally is used; thereby, the light is reflected wholly so as to have a preferred illumination.
